(19) United States
(12) Patent Application Publication
(10) Pub. No.: US 2010/0107189 A1
(43) Pub. Date: Apr. 29, 2010

(54) Barcode advertising

(76) Inventors: Ryan Steelberg, Irvine, CA (US); Chad Steelberg, Newport Beach, CA (US)

Correspondence Address: Thomas J. McWilliams;Drinker Biddle & Reath LLP, One Logan Square, 18th and Cherry Streets, Philadelphia, PA, 19103-6996, US

(21) Appl. No.: 12/456,133

(22) Filed: Jun. 11, 2009

Related U.S. Application Data
(60) Provisional application No. 61/131,858, filed on Jun. 12, 2008.

(51) Int. Cl. H04N 7/10

(52) U.S. Cl. 725/32

(57) ABSTRACT

A display that may be actually or virtually presented at a televised event venue. The display including at least one advertisement, advertising to the in-person attendees at the televised event or virtually inserted into the televised event venue as if advertising to the in-person attendees at the televised event, and at least one identifying marker coupled to the at least one advertisement, wherein the at least one identifying marker is suitable to provide identification of the at least one advertisement when the at least one advertisement is included within the broadcast of the televised event.

### CROSS REFERENCE TO RELATED APPLICATIONS

This application claims priority to U.S. Provisional Patent Application Ser. No. 61/131,858, entitled “Barcode Advertising”, filed Jun. 12, 2008, which application is hereby incorporated by reference herein as if set forth in the entirety.

### BACKGROUND OF THE INVENTION

The instant invention relates to the field of identification and tracking, and, in particular, to identification and tracking of advertising, and more particularly to the identification and tracking of advertising when the advertising is secondary to a broadcast event.

### DESCRIPTION OF RELATED ART

A barcode is a machine-readable representation of information, often having dark ink on a light background to create high and low reflectance, which varied reflectance may be digitally converted to 1s and 0s. Originally, barcodes stored data in the widths and spacings of printed parallel lines, but today they also come in patterns of dots, concentric circles, and text codes hidden within images. Barcodes can be read by optical scanners called barcode readers, or scanned from an image by special software, for example. Barcodes are widely used to implement Auto ID Data Capture (AIDC) systems that improve the speed and accuracy of computer data entry, among myriad other uses.

With the advent, and widespread popularity, of high-definition television (HDTV), which is a digital television broadcasting system with higher resolution than traditional television systems (NTSC, SECAM, PAL), for both broadcasting and viewing, additional data is created. HDTV is typically digitally broadcast, in part because digital television (DTV) requires less bandwidth for transmission if sufficient video compression is used.

The additional data created through HDTV may provide usefulness in the advertising industry. Advertising is a form of communication for which the purpose is to inform potential customers about products and services and how to obtain and use them. Many advertisements are also designed to generate increased consumption of those products and services through the creation and reinforcement of brand image and brand loyalty. For these purposes, advertisements often contain both factual information and persuasive messages. Every major medium is used to deliver this information and these messages, including: television, radio, movies, magazines, newspapers, video games, the Internet and billboards.

Advertisements can also be seen on the seats of grocery carts, on the walls of an airport walkway, on the sides of buses, heard in telephone hold messages and over in-store public address systems. Advertisements are usually placed anywhere an audience can easily and/or frequently access the visuals and/or audio and/or print featuring the advertised product or service. Such advertising is often placed by an advertising agency on behalf of a company.

Mobile Billboards are flat-panel campaign units having the purpose is of carrying advertisements along dedicated routes selected by clients prior to the start of a campaign. Mobile Billboard companies do not typically carry third-party cargo or freight. Mobile displays are used for various situations in metropolitan areas throughout the world, including: target advertising, one day, and long term campaigns, conventions, sporting events, store openings or other similar promotional events, and big advertisements from smaller companies.

Commercial advertising media can include wall paintings, billboards, street furniture components, printed flyers and rack cards, radio, cinema and television ads, web banners, mobile telephone screens, shopping carts; web popups, skywriting, bus stop benches, human directional, magazines, newspapers, town criers, sides of buses or airplanes (“logojets”), taxicab doors, roof mounts and passenger screens, musical stage shows, subway platforms and trains, elastic bands on disposable diapers, stickers on apples in supermarkets, shopping cart handles, the opening section of streaming audio and video, posters, and the backs of event tickets and supermarket receipts. Any place an “identified” sponsor pays to deliver their message through a medium is advertising.

A way to measure advertising effectiveness is known as ad tracking. This advertising research methodology measures shifts in target market presumptively based upon perceptions about the brand and product or service. These shifts in perception are plotted against the consumers' levels of exposure to the company's advertisements and promotions. The purpose of ad tracking is generally to provide a measure of the combined effect of the media weight or spending level, the effectiveness of the media buy or targeting, and the quality of the advertising executions or creative.

Therefore a need exists for an system that enables tracking of advertising, and particularly advertising displayed at a broadcast event, to be identified and tracked according to the broadcast time the advertisement receives.

### BRIEF SUMMARY OF THE INVENTION

A display that may be actually or virtually presented at a televised event venue. The display including at least one advertisement, advertising to the in-person attendees at the televised event or virtually inserted into the televised event venue as if advertising to the in-person attendees at the televised event, and at least one identifying marker coupled to said at least one advertisement, wherein said at least one identifying marker is suitable to provide identification of said at least one advertisement when said at least one advertisement is included within the broadcast of the televised event.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts and in which:

FIG. 1 there is shown an advertisement with a traceable mark according to an aspect of the present invention; and,

FIG. 2 there is shown a depiction of the traceable advertising system of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical object identification, advertising and tracking systems. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

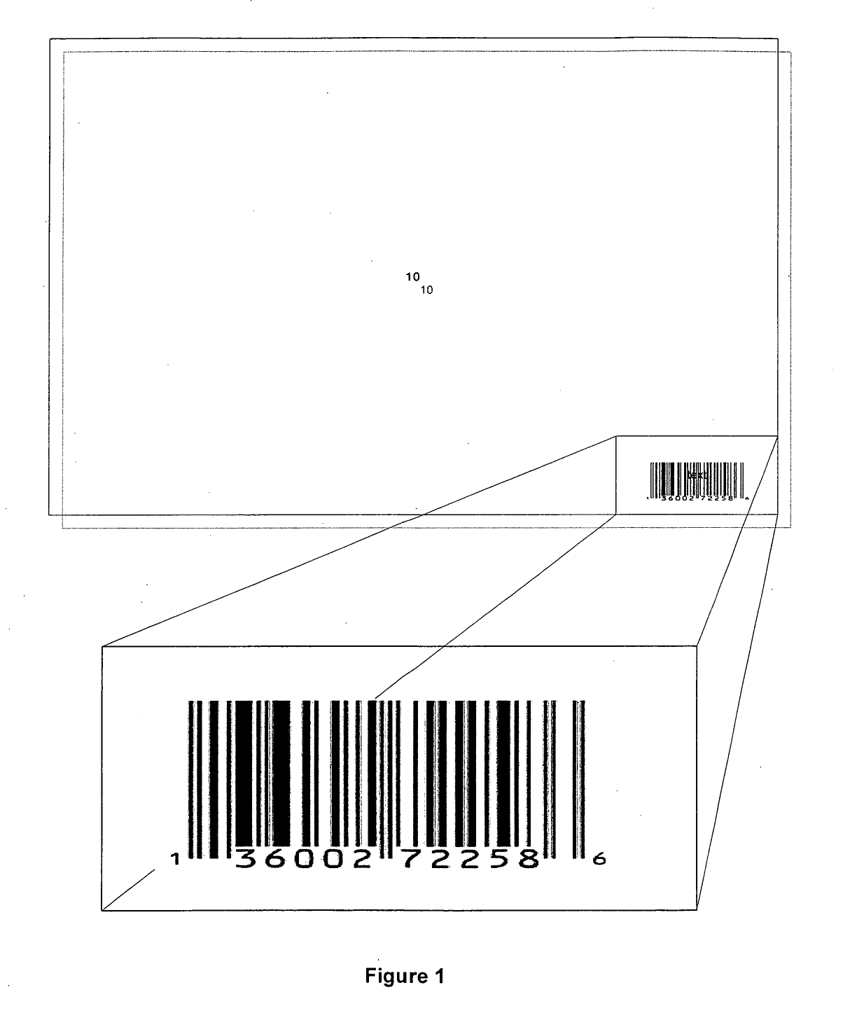

Referring now to FIG. 1, there is shown an advertisement with a traceable mark according to an aspect of the present invention. As may be seen in FIG. 1, there is an advertisement 10 and a traceable mark 20.

Advertisement 10 may take the form of an advertisement as discussed herein throughout. By way of a specific example, advertisement 10 may take the form of a billboard that may be displayed at a sporting event or at a stadium. Of course, such a billboard is exemplary only, and those skilled in the art will appreciate that any advertisement that may be displayed and additionally have included therewith a traceable mark 20 may be utilized according to the present invention. Such advertising forms that would be evident to those possessing an ordinary skill in the pertinent arts might include, for example, banners, large electronic displays, and the like.

Traceable mark 20 may in fact be any type of mark that would be traceable according to the concepts of the present invention. Specifically, traceable mark may take the form of a barcode or watermark, for example. As discussed hereinabove, a barcode may be a computer and/or machine-readable representation of information (such as dark ink on a light background to create high and low reflectance which is converted to 1s and 0s). Barcodes may be stored data in the widths and spacing of printed parallel lines, but also come in patterns of dots, concentric circles, and text codes hidden within images.

Mapping between messages and barcodes and like traceable elements may be performed, and is herein referred to as symbology. A symbology includes the encoding of the single digits/characters of a message, as well as the start and stop markers of a message, into bars and space, generally with a quiet zone required to be before and after the barcode as well as the computation of a checksum.

Linear symbologies can be classified mainly by two properties, namely continuous versus discrete and two width versus many width. Characters in continuous symbologies usually abut, with one character ending with a space and the next beginning with a bar, or vice versa. Characters in discrete symbologies begin and end with bars and the intercharacter space is ignored, as long as it is not wide enough to look like the code ends.

Bars and spaces in two-width symbologies are wide or narrow, although how wide a wide bar is exactly has no significance as long as the symbology requirements for wide bars are adhered to (usually two to three times more wide than a narrow bar). Bars and spaces in many-width symbologies are all multiples of a basic width called the module; with such codes typically using four widths of 1, 2, 3 and 4 modules.

Symbologies may use interleaving. The first character may be encoded using black bars of varying width. The second character may then be encoded, by varying the width of the white spaces between these bars. Thus characters may be encoded in pairs over the same section of the barcode, interleaved 2 of 5, for example.

Stacked symbologies may include a given linear symbology repeated vertically in multiple. There may also be 2-D symbologies which include matrix codes featuring square or dot-shaped modules arranged on a grid pattern. 2-D symbologies also come in a variety of other visual formats. Aside from circular patterns, there are several 2-D symbologies which employ steganography by hiding an array of different-sized or -shaped modules within a user-specified image, dataglyphs, for example.

A barcode may be matched to a given advertisement such that the discovery of that barcode in a data stream or display corresponds to the given advertisement having been displayed or streamed. Alternatively, the barcode may have encoded information that, upon discovery of the barcode in a data stream or display, may be decoded concurrently or in later processing to determine the advertisement that was present in the data stream or display. Under a matched case scenario, after discovery of the barcode in the display or data stream, a conversion from the barcode to the advertisement may be performed, in part to determine the timing of the advertisement in the display or data stream. Under an encoding scenario, the bar code may be encoded with information to provide inventory type information and further enable high level scan information. Such high level information may identify the advertisement as Coke, for example, but not necessarily identify the particular advertisement itself. This would allow Coke to determine the overall coverage and presentation of its products and advertising without actually determining the particulars of the advertisements that were displayed or streamed. Such particular information may, however, be determined through further analysis using the information encoded via the present invention.

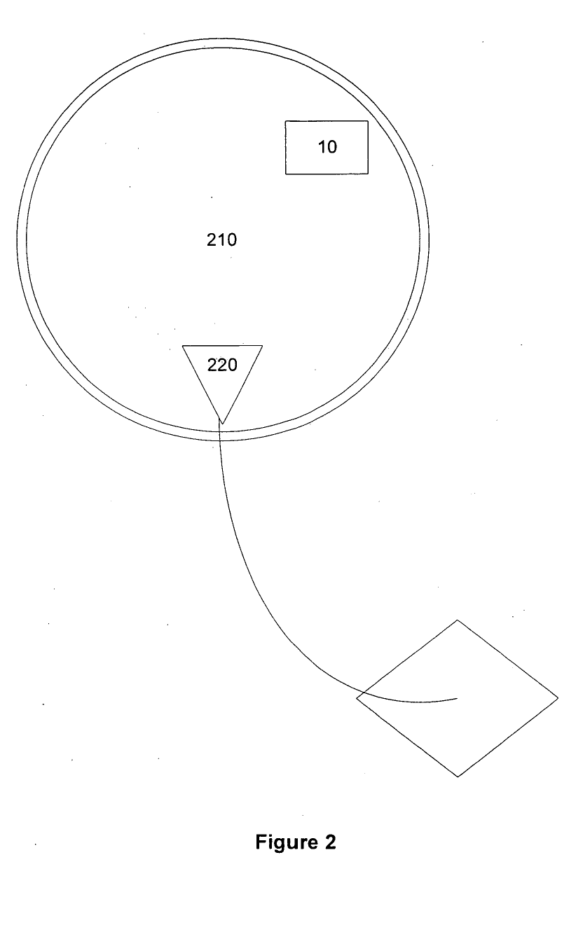

Referring now additionally to FIG. 2, there is depicted a system of the present invention. As may be seen in FIG. 2, a venue 210 containing an advertisement 10 that contains, or has imprinted thereon, a marker 20, may be recorded using a transformer 220, thereby transforming the image, sound or other rendition of advertisement 10 and marker 20 into another medium, such a electromagnetic waves, for example. Needless to say, the marker may lend itself to providing varied data if the marker is transformatively displayed off angle or partially, or the like. For example, the marker may include keys that are read to assess how much of the marker, or advertisement, is displayed, as discussed hereinthroughout, and/or may be or aspects, such as colors, holograms, or angular antennae or receivers that may indicate the angle of view of the transformative broadcasting agent.

In the example of a billboard at a live sporting event, a high definition camera system may be used as the transformer 220. Such a camera system may digitize the image of the stadium and the underlying sports action such that a digital signal containing this information may be transmitted or broadcast to a viewing audience. In that situation, the viewing audience may view the billboard advertisement that was displayed at the venue and was captured by the high definition camera system. Having a marker associated with the advertisement may create the ability to monitor the transmission of the event for the appearance of such marker, and to identify the timing of the presentation of the marker to thereby determine the amount of time the associated advertisement was displayed during the broadcast. From this timing information and the associated viewing audience information, such as the Nielson ratings discussed herein below, a numerical value may be associated with the viewership of the venue display advertisement.

Further, using the sporting event example, and examining the effects that a television commercial has during, for example, the Super Bowl, it may be readily apparent the need to track the display of billboard advertising within the Super Bowl broadcast. In this regard, the television commercial is generally considered the most effective mass-market advertising format, as reflected by the high prices TV networks charge for commercial airtime during popular TV events. The annual Super Bowl football game in the United States is known as the most prominent advertising event on television. The average cost of a single thirty-second TV spot during this game has reached $2.7 million (as of 2007). However, advertising displayed at the Super Bowl venue, and thereby shown on the Super Bowl broadcast, particular in the high definition version of that broadcast, may be obtained at a very significantly lower rate than the advertising rates for a 30 second TV spot, for example.

Virtual advertisements may be inserted into regular television programming through computer graphics. Such virtual ads are typically inserted into otherwise blank backdrops or used to replace local billboards that are not relevant to the remote broadcast audience. Virtual billboards may be inserted into the background where none exist in real-life. Virtual product placement is also possible. Such virtual advertisements have been commonly found in basketball broadcasts, wherein logos are been virtually displayed just beyond the three-point lines, for example. In baseball, such virtual advertisements have been found on the walls behind home plate and the batter, for example. In such situations, the advertisements may be manipulated such that a scrolling or changing display may be used—either in a real-time display or virtually.

Advertising on the World Wide Web is a recent phenomenon. Prices of Web-based advertising space are dependent on the “relevance” of the surrounding web content and the traffic that the website receives. E-mail advertising is another recent phenomenon. Unsolicited bulk E-mail advertising is known as “spam”. Interstitial advertisement is a form of advertisement which takes place while a web page loads. Controversy exists on the effectiveness of subliminal advertising, and the pervasiveness of mass messages.

The mobile phone became a new mass media in 1998, when the first paid downloadable content appeared on mobile phones in Finland. It was only a matter of time until mobile advertising followed, also first launched in Finland in 2000. These mobile devices may, in the future, be available with high definition displays as well.

One type of mobile ad is based on SMS (Short Message Service) text messages. SMS has become the largest data application on the planet with over 2.4 billion active users. The addition of a text-back number is gaining prevalence as quickly as the “www” address had previously. The benefit of SMS text messages is people can respond where they are, right now, even if stuck in traffic or sitting on the metro. The use of SMS text messages can also be a great way to get a viral (word-of-mouth) campaign off the ground to build a own database of prospects.

More advanced mobile ads include banner ads, coupons, MMS picture and video messages, advergames and various engagement marketing campaigns. A particular feature driving mobile ads is the 2D Barcode, which replaces the need to do any typing of web addresses, and uses the camera feature of modern phones to gain immediate access to web content.

The most common method for measuring the impact of mass media advertising is the use of the rating point (rp), or the more accurate target rating point (trp). These two measures refer to the percentage of the universe of an existing base of audience members that can be reached by the use of each media outlet in a particular moment in time. The difference between the two is that the rating point refers to the percentage of the entire universe, while the target rating point refers to the percentage of a particular segment or target. This becomes very useful when focusing advertising efforts on a particular group of people. One of the reasons advertising is successful is because it can target a particular audience to build awareness of what the advertiser has to offer.

High-definition television (HDTV) is a digital television broadcasting system with higher resolution than traditional television systems (NTSC, SECAM, PAL). HDTV broadcast systems are defined threefold, by the scanning methodology, lines of vertical resolution, and frame rate.

The scanning system of an HDTV typically employs one of a progressive scanning (p) or an interlaced scanning (i). Progressive scanning simply draws a complete image frame (all the lines) per image refresh, whereas interlaced scanning draws a partial image field (every second line) during a first pass, then fills-in the remaining lines during a second pass, per image refresh. Interlaced scanning requires significantly lower signal/data bandwidth, but an interlaced signal loses half of the vertical resolution and suffers “combing” artifacts when showing a moving subject on a progressive display (although the worst effects can be mitigated by suitable image post-processing known as ‘deinterlacing’). To compensate, however, interlaced mode provides finer time-sampling, giving two (half-resolution) image samples in the same time interval as one (full-resolution) image sample in progressive mode.

The 720p60 format is 1280×720 pixels progressive scanning with 60 fields per second (120 Hz). The 1080i50 format is 1920×1080 pixels (ie 2 MP) interlaced scanning with 50 fields per second. Sometimes interlaced fields are called half-frames, but they are not, because two fields of one frame are temporally shifted. Frame pulldown and segmented frames are special techniques that allow transmitting full frames via an interlaced video stream.

For commercial naming of the product, either the frame rate or the field rate is often dropped, e.g. a “1080i television set” label indicates only the image resolution. Often, the rate is inferred from the context, usually assumed to be either 50 or 60 Hz, except for 1080p, which denotes 1080p24, 1080p25, and 1080p30, but may include 1080p50 and 1080p60 in the future.

A frame or field rate can also be specified without a resolution. For example 24p means 24 progressive scan frames per second, and 50i means 25 interlaced frames per second consisting of 50 interlaced fields per second. Most HDTV systems support some standard resolutions and frame or field rates. The capability to determine that the marker is in the frame may be dependent on the resolution of the underlying broadcast, that is, the underlying broadcast may or may not be in high definition.

Data that is of sufficient quality for HDTV, or another high definition medium, may be analyzed for evidence of a marker according to an aspect of the present invention. In particular, this analysis may take place using the display medium of a television or may occur directly on the underlying data itself, or a combination of the data and the broadcast may be used. In order to reduce the level of computation involved, it may be possible to search the data or display for some hallmark of a marker, and then once that artifact is detected analyze the data or display further to determine the identity of the marker, or match the marker to an advertisement, and/or determine the time length of display and viewership factor of the medium.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

What is claimed is:

1. A broadcast presented from a televised event venue, comprising:
at least one advertisement for advertising to the in-person attendees at the televised event venue;
at least one identifying marker coupled to said at least one advertisement, wherein said at least one identifying marker is suitable to provide identification of said at least one advertisement whenever said at least one advertisement appears within the broadcast of the televised event.

2. The broadcast of claim 1, wherein said at least one identifying marker suitably avoids disruption of said at least one advertisement to the in-person attendees at the televised event.

3. The broadcast of claim 1, wherein said at least one identifying marker includes a barcode.

4. The broadcast of claim 3, wherein said barcode includes a direct identification of at least one aspect of said at least one advertisement.

5. The broadcast of claim 4, wherein said barcode uniquely identifies said at least one advertisement.

6. The broadcast of claim 5, wherein said unique identification includes at least advertiser, product and identifying features of said at least one advertisement.

7. The broadcast of claim 1, wherein said at least one identifying marker includes a lower resolution scan that effectively retrieves a subset of the overall information included in the at least one identifying marker without requiring the level of resolution to discern all of the information encoded in the at least one identifying marker.

8. The broadcast of claim 1, wherein said at least one identifying marker identifies said at least one advertisement.

9. The broadcast of claim 8, wherein said identification includes at least advertiser, product and identifying features of said at least one advertisement.

10. The broadcast of claim 1, wherein said at least one advertisement is a billboard.

11. A display that may be virtually presented at a televised event venue, said display comprising:
at least one advertisement virtually inserted into the televised event venue as if advertising to the in-person attendees at the televised event;
at least one identifying marker coupled to said at least one advertisement, wherein said at least one identifying marker is suitable to provide identification of said at least one advertisement when said at least one advertisement is included within the broadcast of the televised event.

12. The display of claim 11, wherein said at least one identifying marker includes a barcode.

13. The display of claim 12, wherein said barcode includes a direct identification of at least one aspect of said at least one advertisement.

14. The display of claim 13, wherein said barcode uniquely identifies said at least one advertisement.

15. The display of claim 14, wherein said unique identification includes at least advertiser, product and identifying features of said at least one advertisement.

16. The display of claim 11, wherein said at least one identifying marker includes a lower resolution scan that effectively retrieves a subset of the overall information included in the at least one identifying marker without requiring the level of resolution to discern all of the information encoded in the at least one identifying marker.

17. The display of claim 1, wherein said at least one identifying marker identifies said at least one advertisement.

18. The display of claim 17, wherein said identification includes at least advertiser, product and identifying features of said at least one advertisement.

19. The display of claim 11, wherein said at least one advertisement is a billboard.

20. A method of monitoring displayed at venue advertisements during a broadcast of the venued event, said method comprising:
providing at least one advertisement for advertising to the in-person attendees at the event venue;
marking said at least one advertisement, wherein said at least one identifying marker is suitable to provide identification of said at least one advertisement whenever said at least one advertisement appears within the broadcast of the venued event.
